(19) United States
(12) Patent Application Publication
(10) Pub. No.: US 2024/0101076 A1
(43) Pub. Date: Mar. 28, 2024

(54) Vehicle Washing Device

(71) Applicant: Ponsiano Jimenez, Bellflower, CA (US)

(72) Inventor: Ponsiano Jimenez, Bellflower, CA (US)

(21) Appl. No.: 17/953,296

(22) Filed: Sep. 26, 2022

(51) Int. Cl. B60S 3/04; A45F 3/04; A46B 5/00; A46B 5/02; A46B 11/00; A46B 15/00

(52) U.S. Cl. CPC B60S 3/047; A45F 3/04; A46B 5/005; A46B 5/0095; A46B 5/02; A46B 11/002; A46B 11/0062; A46B 11/0072; A46B 15/0004; A46B 2200/3046

(57) ABSTRACT

A vehicle washing device for cleaning a vehicle includes a handgrip, which is attached to a first end of an elongate handle. A pump is attached to the handgrip and is in fluidic communication with a reservoir that contains a cleaning solution. Each of a plurality of brush heads is attachable to a second end of the elongate handle so that the brush head is in fluidic communication with the pump. A battery is attachable to the handgrip to power the pump to motivate the cleaning solution from the reservoir to the brush head. A switch on the handgrip and is operationally engaged to the battery and the pump. The handgrip is grasped in a hand of a user, positioning the user to manipulate the brush head on a surface and to switch the switch to actuate the pump so that the cleaning solution is applied to the surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to washing devices and more particularly pertains to a new washing device for cleaning a vehicle. The present invention discloses a washing device comprising an elongate handle with a handgrip and a switch actuated pump that motivates a cleaning solution from a reservoir to a brush head, allowing a user to clean surfaces without bending at the waist.

### (2) Description of Related Art Including Information Disclosed Under 37 CFR 1.97 and 1.98

The prior art relates to washing devices, which may comprise handled brushes, which may have attached reservoirs or wherein the handles serve as reservoirs, spray head with cleaning fluid regulators, hollow shafts with hose attachments at one end and rotating brushes on the other and a reservoir in between, and brushes with reservoirs and pumps. What is lacking in the prior art is a washing device comprising an elongate handle with a handgrip and a switch actuated pump that motivates a cleaning solution from a reservoir to a brush head.

### BRIEF SUMMARY OF THE INVENTION

An embodiment of the disclosure meets the needs presented above by generally comprising a handgrip, which is hollow and attached to a first end of an elongate handle. A reservoir is attached to the handgrip and is configured to contain a cleaning solution. A pump is attached to and is positioned in the handgrip. The pump is in fluidic communication with the reservoir. Each of a plurality of brush heads is selectively attachable to a second end of the elongate handle so that the brush head is in fluidic communication with the pump. A battery is selectively attachable to the handgrip to selectively power the pump to motivate the cleaning solution from the reservoir to the brush head. A switch is attached to the handgrip and is operationally engaged to the battery and the pump. The handgrip is configured to be grasped in a hand of a user, positioning the user to manipulate the brush head on a surface and to switch the switch to actuate the pump so that the cleaning solution is applied to the surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side view of a vehicle washing device according to an embodiment of the disclosure.

FIG. 2 is an end view of an embodiment of the disclosure.

FIG. 3 is a top view of an embodiment of the disclosure.

FIG. 4 is a side view of an embodiment of the disclosure.

FIG. 5 is a detail view of an embodiment of the disclosure.

FIG. 6 is a detail view of an embodiment of the disclosure.

FIG. 7 is a detail view of an embodiment of the disclosure.

FIG. 8 is an in-use view of an embodiment of the disclosure.

### DETAILED DESCRIPTION OF THE INVENTION

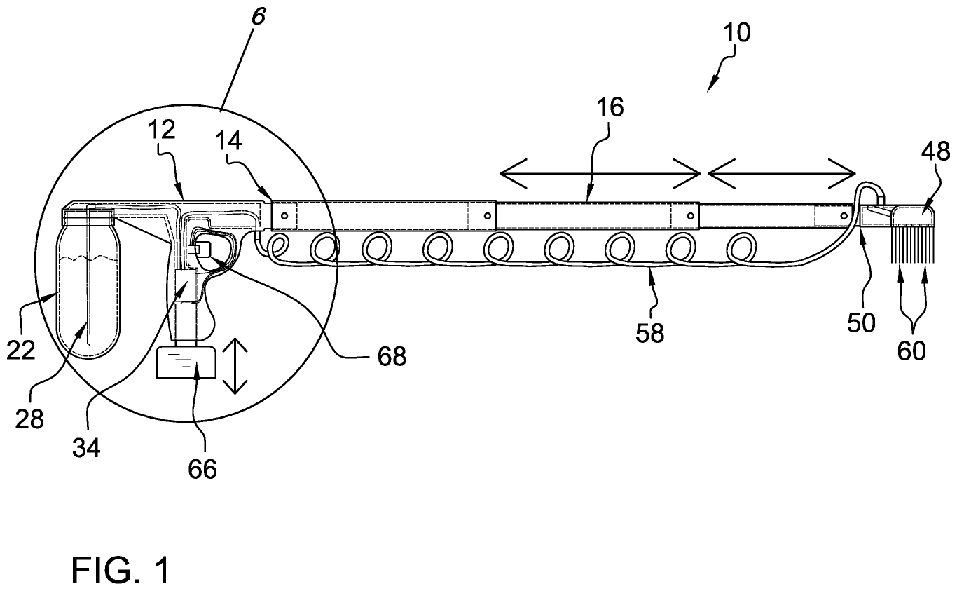

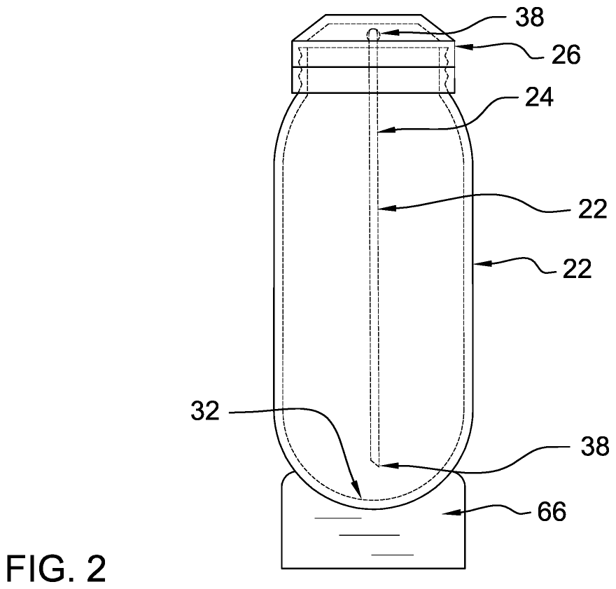

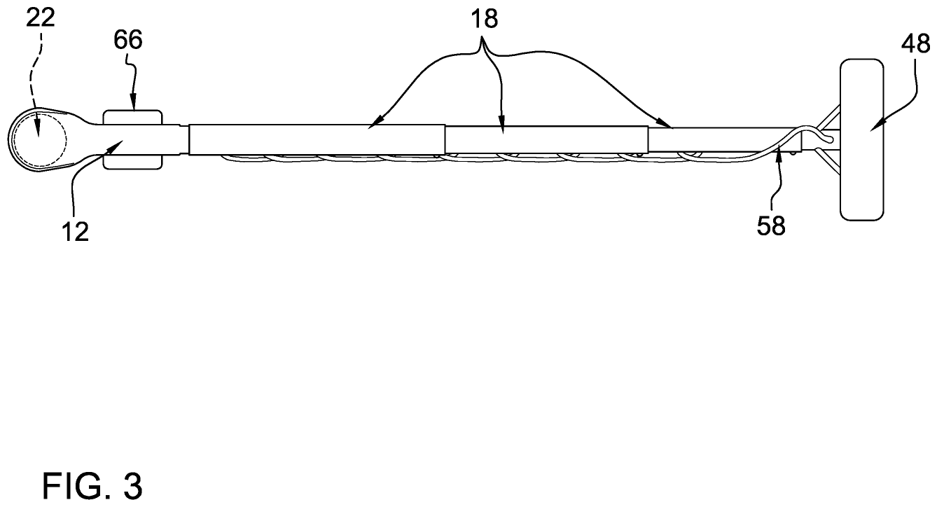

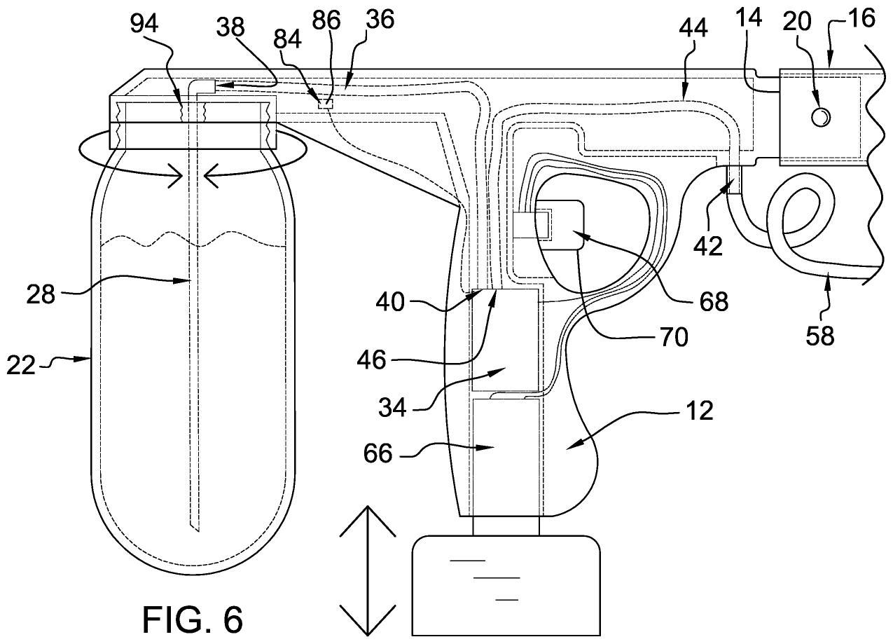

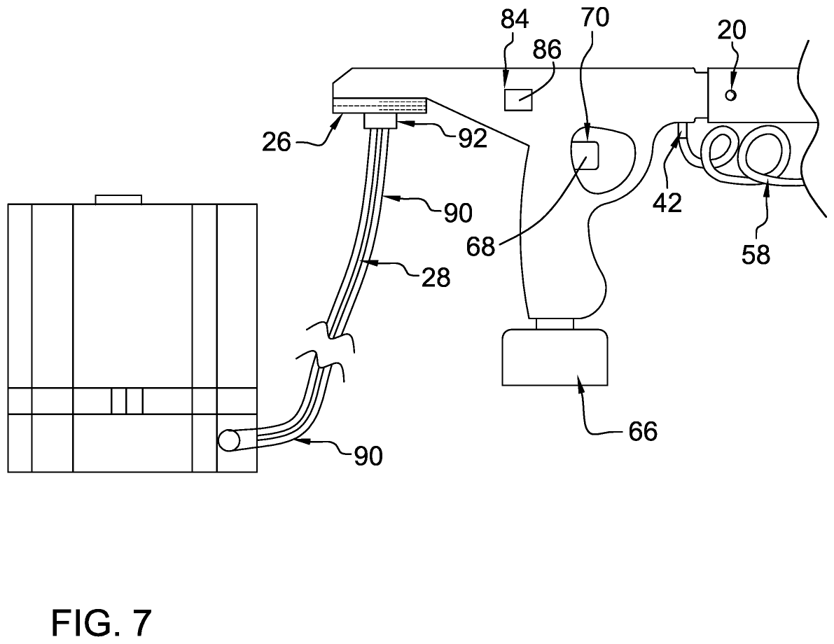

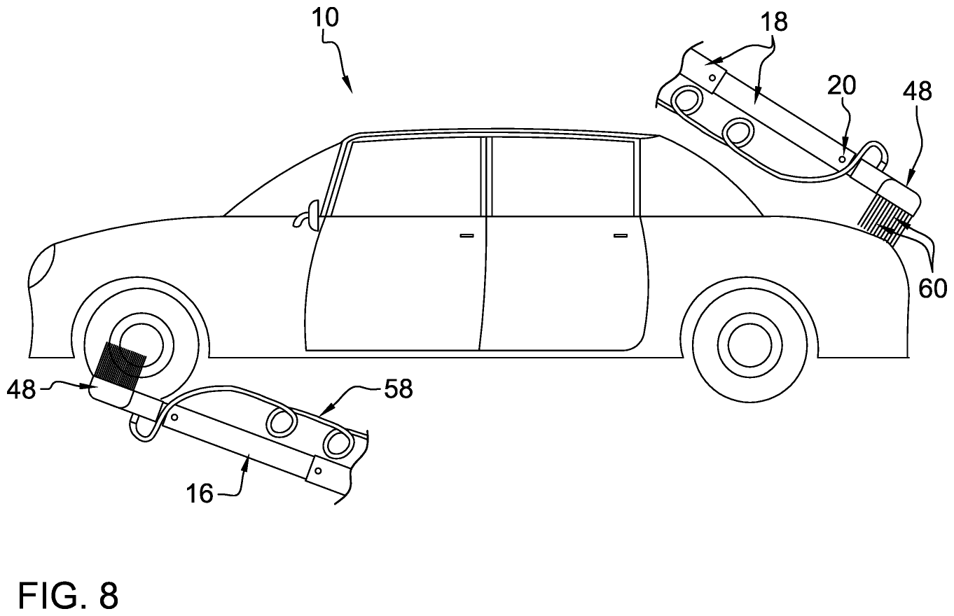

With reference now to the drawings, and in particular to FIGS. 1 through 8 thereof, a new washing device embodying the principles and concepts of an embodiment of the disclosure and generally designated by the reference numeral 10 will be described.

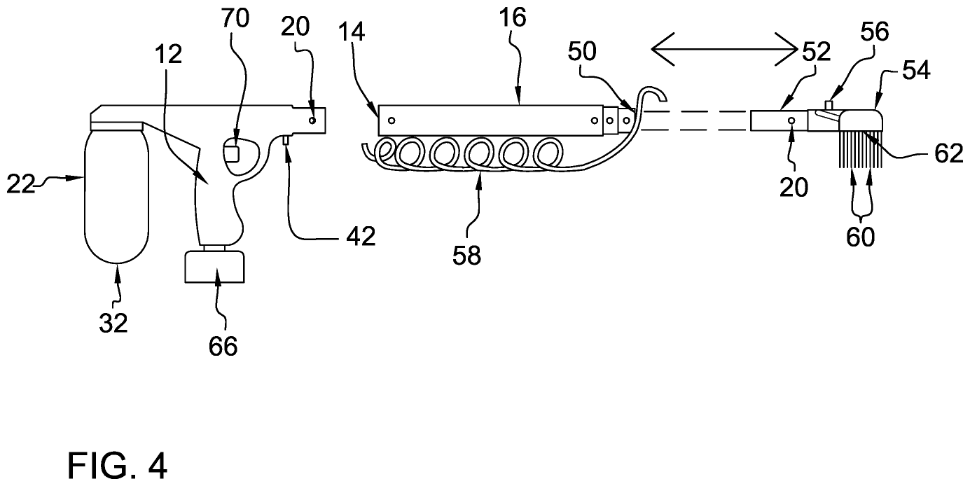

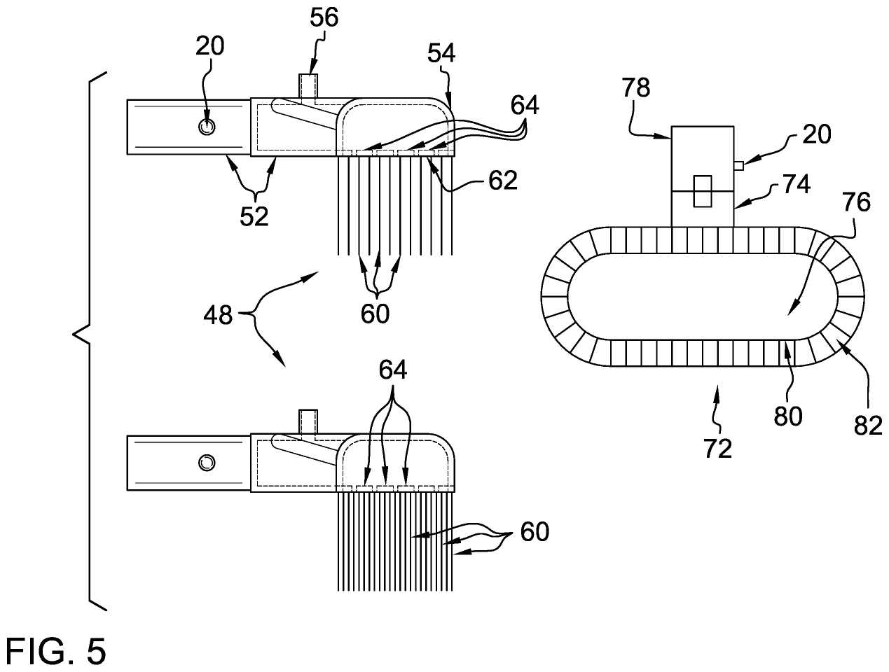

As best illustrated in FIGS. 1 through 8, the vehicle washing device 10 generally comprises a handgrip 12, which is hollow and which is attached to a first end 14 of an elongate handle 16. The elongate handle 16 comprises a plurality of nested sections 18 so that the elongate handle 16 is selectively extensible. Adjacent nested sections 18 may be locked into place by means known to those skilled in the art of extendable handles, such as, but not limited, spring loaded pins 20, as shown in FIGS. 4 and 5, twist locks, and the like. The handgrip 12 may be reversibly attachable to the elongate handle 16, as shown in FIG. 4, allowing a user to utilize the vehicle washing device 10 without the mass of the handgrip 12 and any components attached to the handgrip 12.

A reservoir 22 is attached to the handgrip 12 and is configured to contain a cleaning solution, such as a soap solution. The reservoir 22 has a neck 24, which is externally threaded and complementary to a cap 26, which is attached to the handgrip 12. The cap 26 is internally threaded so that the cap 26 is positioned for selective threaded insertion of the neck 24 to removably attach the reservoir 22 to the handgrip 12. A straw 28 is attached to the cap 26 and extends into the reservoir 22 so that a lower end 30 of the straw 28 is positioned proximate to a bottom 32 of the reservoir 22.

A pump 34 is attached to and is positioned in the handgrip 12. The pump 34 is in fluidic communication with the reservoir 22. A first tube 36 extends from an upper end 38 of the straw 28 through the handgrip 12 to an inlet port 40 of the pump 34. A first connector 42 is attached to the handgrip 12 proximate to the first end 14 of the elongate handle 16. A second tube 44 extends between an outlet port 46 of the pump 34 and the first connector 42.

Each of a plurality of brush heads 48 is selectively attachable to a second end 50 of the elongate handle 16 so that the brush head 48 is in fluidic communication with the pump 34. The brush head 48 comprises a stem 52, which is selectively insertable into the second end 50 of the elongate handle 16 so that the brush head 48 is removably attached to the elongate handle 16. A shell 54 is attached to the stem 52 and may be elongated so that the shell 54 extends bidirectionally from the second end 50 of the elongate handle 16. A second connector 56 is attached to the shell 54. A coiled hose 58 is selectively attachable to the first connector 42 and the second connector 56 to fluidically engage the shell 54 to the pump 34.

A plurality of bristles 60 is attached to and extends from a facet 62 of the shell 54. The bristles 60 of the plurality of bristles 60 have a respective stiffness so that the plurality of brush heads 48 comprises brush heads 48 having pluralities of bristles 60 having a variety of stiffnesses. For example, a brush head 48 with bristles 60 that are stiff would be useful in cleaning tires and rims of a vehicle, while a brush head 48 with softer bristles 60 would be useful in cleaning painted surfaces and windows of the vehicle. A plurality of holes 64 is positioned in the facet 62 and is configured for passage of the cleaning solution from the shell 54 to the bristles 60 and the surface.

A battery 66 is selectively attachable to the handgrip 12 to selectively power the pump 34 to motivate the cleaning solution from the reservoir 22 to the brush head 48. A switch 68 is attached to the handle and is operationally engaged to the battery 66 and the pump 34. The switch 68 may comprise a trigger 70. The handgrip 12 is configured to be grasped in a hand of a user, positioning the user to manipulate the brush head 48 on the surface and to switch the switch 68 to actuate the pump 34 so that the cleaning solution is applied to the surface.

A controller 84 may be attached to the elongate handle 16 and operationally engaged to the pump 34. The controller 84 is configured to set the pump 34 to a variety of operational speeds. For example, the controller 84 may comprise a depressible button 86, which can be dressed a first time, a second time, and a third time to set the pump to slow, medium, and high levels of operational speeds, respectively.

A drying pad 72 is selectively attachable to the second end 50 of the elongate handle 16. The handgrip 12 is configured to be grasped in the hand of the user, positioning the user to manipulate the drying pad 72 on a surface to dry the surface. The handgrip 12 also may be detached from the elongate handle 16, allowing the user to dry the surface without dealing with the mass of the handgrip 12, the reservoir 22, and the battery 66.

The drying pad 72 may comprise a first stub 74, which is attached to a plate 76. A second stub 78 is hingedly attached to the first stub 74 so that the plate 76 is selectively hingable relative to the elongate handle 16. The second stub 78 is selectively insertable into the second end 50 of the elongate handle 16 so that the drying pad 72 is removably attached to the elongate handle 16. A cloth 80 is selectively attachable to the plate 76 by means know to those skilled in the art of drying pads such as elastic bands 82, as shown in FIG. 5, hook and loop fasteners, pressure sensitive adhesives, and the like.

The vehicle washing device 10 also may comprise a backpack 88 from which a connector hose 90 extends. The backpack 88 is substantially impermeable and is configured to contain a cleaning solution. The backpack 88 may be sized to contain 2.00 to 6.00 L of cleaning solution. The backpack 88 may be sized to contain 3.75 to 4.25 L of cleaning solution. A female hose connector 92, which is attached to the connector hose 90 distal from the backpack 88, is complementary to a male hose connector 94 attached to the cap 26 and positioned around the straw 28. The backpack 88 can be employed when the reservoir 22 is not sufficient to supply an adequate amount of cleaning solution for a particular cleaning job.

In use, a cleaning solution is added to the reservoir 22, which then is attached to the handgrip 12. The handgrip 12 is grasped in a hand of a user, positioning the user to manipulate the brush head 48 on a surface and to actuate the pump 34 so that the cleaning solution is applied to the surface.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle washing device comprising:
an elongate handle;
a handgrip attached to a first end of the elongate handle, the handgrip being hollow;
a reservoir attached to the handgrip and being configured for positioning of a cleaning solution;
a pump attached to and positioned in the handgrip, the pump being in fluidic communication with the reservoir;
a plurality of brush heads, each brush head being selectively attachable to a second end of the elongate handle, such that the brush head is in fluidic communication with the pump;
a battery selectively attachable to the handgrip, such that the battery is enabled for selectively powering the pump for motivating the cleaning solution from the reservoir to the brush head; and
a switch attached to the handgrip and being operationally engaged to the battery and the pump, wherein the handgrip is configured for grasping in a hand of a user, positioning the user for manipulating the brush head on a surface and for switching the switch for actuating the pump, such that the cleaning solution is applied to the surface.

2. The vehicle washing device of claim 1, wherein the elongate handle comprises a plurality of nested sections, such that the elongate handle is selectively extensible.

3. The vehicle washing device of claim 1, further including:
the reservoir having a neck, the neck being externally threaded;
a cap attached to the handgrip, the cap being internally threaded, such that the cap is positioned for selective threaded insertion of the neck for removably attaching the reservoir to the handgrip.

4. The vehicle washing device of claim 3, further including:
a straw attached to the cap and extending into the reservoir, such that a lower end of the straw is positioned proximate to a bottom of the reservoir;
a first tube extending from an upper end of the straw through the handgrip to an inlet port of the pump;
a first connector attached to the handgrip proximate to the first end of the elongate handle;
a second tube extending between an outlet port of the pump and the first connector;
the brush head comprising:
a stem selectively insertable into the second end of the elongate handle, such that the brush head is removably attached to the elongate handle,
a shell attached to the stem,
a second connector attached to the shell,
a plurality of bristles attached to and extending from a facet of the shell, the bristles of the plurality of bristles having a respective stiffness, such that the plurality of brush heads comprises brush heads having pluralities of bristles having a variety of stiffnesses, and
a plurality of holes positioned in the facet, wherein the holes are configured for passage of the cleaning solution from the shell to the bristles and the surface; and
a coiled hose selectively attachable to the first connector and the second connector for fluidically engaging the shell to the pump;

5. The vehicle washing device of claim 1, wherein the shell is elongated, such that the shell extends bidirectionally from the second end of the elongate handle.

6. The vehicle washing device of claim 1, wherein the switch comprises a trigger.

7. The vehicle washing device of claim 6 further including a controller attached to the elongate handle and operationally engaged to the pump, the controller being configured to set the pump to a variety of operational speeds.

8. The vehicle washing device of claim 7, wherein the controller comprises a depressible button, the depressible button being depressible a first time, a second time, and a third time for setting the pump to slow, medium, and high levels of operational speeds, respectively.

9. The vehicle washing device of claim 1, further including a drying pad selectively attachable to the second end of the elongate handle, wherein the handgrip is configured for grasping in the hand of the user, positioning the user for manipulating the drying pad on a surface for drying the surface.

10. The vehicle washing device of claim 9, wherein the drying pad comprises:
a plate;
a first stub attached to the plate;
a second stub hingedly attached to the first stub, such that the plate is selectively hingable relative to the elongate handle, the second stub being selectively insertable into the second end of the elongate handle, such that the drying pad is removably attached to the elongate handle; and
a cloth selectively attachable to the plate.

11. The vehicle washing device of claim 1, further including the handgrip being reversibly attachable to the elongate handle.

12. The vehicle washing device of claim 4, further including:
a backpack, the backpack being substantially impermeable, wherein the backpack is configured for containing a cleaning solution;
a female hose connector attached to the connector hose distal from the backpack;
a male hose connector attached to the cap and positioned around the straw, the male hose connector being complementary to the female hose connector, such that the backpack is selectively fluidically engageable to the pump.

13. The vehicle washing device of claim 12, wherein the backpack is sized to contain 2.00 to 6.00 L of cleaning solution.

14. The vehicle washing device of claim 13, wherein the backpack is sized to contain 3.75 to 4.25 L of cleaning solution.

15. A vehicle washing device comprising:
an elongate handle, the elongate handle comprising a plurality of nested sections, such that the elongate handle is selectively extensible;
a handgrip attached to a first end of the elongate handle, the handgrip being hollow, the handgrip being reversibly attachable to the elongate handle;
a reservoir attached to the handgrip and being configured for positioning of a cleaning solution, the reservoir having a neck, the neck being externally threaded;
a cap attached to the handgrip, the cap being internally threaded, such that the cap is positioned for selective threaded insertion of the neck for removably attaching the reservoir to the handgrip;
a straw attached to the cap and extending into the reservoir, such that a lower end of the straw is positioned proximate to a bottom of the reservoir;
a pump attached to and positioned in the handgrip, the pump being in fluidic communication with the reservoir;
a first tube extending from an upper end of the straw through the handgrip to an inlet port of the pump;
a first connector attached to the handgrip proximate to the first end of the elongate handle;
a second tube extending between an outlet port of the pump and the first connector;
a plurality of brush heads, each brush head being selectively attachable to a second end of the elongate handle, such that the brush head is in fluidic communication with the pump, the brush head comprising:
a stem selectively insertable into the second end of the elongate handle, such that the brush head is removably attached to the elongate handle,
a shell attached to the stem, the shell being elongated, such that the shell extends bidirectionally from the second end of the elongate handle;
a second connector attached to the shell,
a plurality of bristles attached to and extending from a facet of the shell, the bristles of the plurality of bristles having a respective stiffness, such that the plurality of brush heads comprises brush heads having pluralities of bristles having a variety of stiffnesses, and
a plurality of holes positioned in the facet, wherein the holes are configured for passage of the cleaning solution from the shell to the bristles and the surface;
a coiled hose selectively attachable to the first connector and the second connector for fluidically engaging the shell to the pump;
a battery selectively attachable to the handgrip, such that the battery is enabled for selectively powering the pump for motivating the cleaning solution from the reservoir to the brush head;
a switch attached to the handgrip and being operationally engaged to the battery and the pump, wherein the handgrip is configured for grasping in a hand of a user, positioning the user for manipulating the brush head on a surface and for switching the switch for actuating the pump, such that the cleaning solution is applied to the surface, the switch comprising a trigger;
a controller attached to the elongate handle and operationally engaged to the pump, the controller being configured to set the pump to a variety of operational speeds, the controller comprising a depressible button, the depressible button being depressible a first time, a second time, and a third time for setting the pump to slow, medium, and high levels of operational speeds, respectively;
a drying pad selectively attachable to the second end of the elongate handle, wherein the handgrip is configured for grasping in the hand of the user, positioning the user for manipulating the drying pad on a surface for drying the surface, the drying pad comprising:
a plate,
a first stub attached to the plate,
a second stub hingedly attached to the first stub, such that the plate is selectively hingable relative to the elongate handle, the second stub being selectively insertable into the second end of the elongate handle, such that the drying pad is removably attached to the elongate handle, and
a cloth selectively attachable to the plate;
a backpack, the backpack being substantially impermeable, wherein the backpack is configured for containing a cleaning solution, the backpack being sized to contain 2.00 to 6.00 L of cleaning solution, the backpack being sized to contain 3.75 to 4.25 L of cleaning solution;
a female hose connector attached to the connector hose distal from the backpack; and
a male hose connector attached to the cap and positioned around the straw, the male hose connector being complementary to the female hose connector, such that the backpack is selectively fluidically engageable to the pump
